(19) United States
(12) Patent Application Publication
(10) Pub. No.: US 2020/0272533 A1
(43) Pub. Date: Aug. 27, 2020

(54) DETECTING MEMORY MISMATCH BETWEEN LOCKSTEP SYSTEMS USING A MEMORY SIGNATURE

(71) Applicant: Intel Corporation, Santa Clara, CA (US)

(72) Inventors: Kenneth W. PRIVITT, San Diego, CA (US); Scott RIDER, Beaverton, OR (US)

(21) Appl. No.: 16/874,137

(22) Filed: May 14, 2020

(51) Int. Cl. G06F 11/07; G06F 11/10; G06F 11/14; G06F 9/52; G06F 9/30; G06F 13/16; G06F 21/64; G06F 21/60

(52) U.S. Cl. CPC G06F 11/0772; G06F 11/1004; G06F 11/1441; G06F 9/524; G06F 2201/835; G06F 13/1689; G06F 21/64; G06F 21/602; G06F 9/30101

(57) ABSTRACT

Examples include a first computer system operating in lockstep with a second computer system. The first computer system includes a first signature generator to generate a first digital signature representing a first write operation by a first memory controller to a first memory, the first write operation to store data at an address in the first memory, and a first signature register to store the first digital signature. The second computer system includes a second signature generator to generate a second digital signature representing a second write operation by a second memory controller to a second memory, the second write operation to store the data at the address in the second memory, and a second signature register to store the second digital signature. The first digital signature is compared to the second digital signature and a lockstep error is detected when the first digital signature does not match the second digital signature.

### TECHNICAL FIELD

Examples described herein are generally related to high reliability, multiple computer systems and more particularly to high reliability, multiple computer systems in which write data is processed (compared or copied) outside of checkpoint operations.

### BACKGROUND

Some high reliability computer systems use a process known as checkpointing to keep a second computer system in software lockstep with a first computer system. Periodically, the first computer system is stopped and the Central Processing Unit (CPU) state and any changes to the first computer system's memory since the last checkpoint are compared to the second computer system. In the event of a failure or unrecoverable error on the first computer system, the second computer system will continue execution from the last checkpoint. Through frequent checkpointing, a second computer system can take over execution of a user's application with little noticeable impact to the user.

Memory controllers are included in computer CPUs to access a separate attached external system memory. In most high-performance computer systems, the CPU includes an internal cache memory to cache a portion of the system memory and uses the internal cache memory for the majority of all memory reads and writes. When the internal cache memory is full of changed data and the CPU desires to write additional changed data to the cache, the memory controller writes a copy of some of the cache content to external system memory.

High reliability computer systems use mirrored memory. A computer system may have memory configured to be in “mirror” mode. When memory is in mirrored mode, the memory controller which is responsible for reading the contents of external memory to the CPU or writing data to the external memory from the CPU writes two copies of the data to two different memory locations, a primary and secondary side of the mirror. When the memory controller is reading the data back into the CPU, the memory controller only needs to read one copy of the data from one memory location. If the data being read from the primary side has been corrupted and has uncorrectable errors in the data, the memory controller reads the mirror memory secondary location to get the other copy of the same data. As long as the memory controller is performing a read operation, the memory controller only needs to read from a single memory location. Whenever the memory controller is performing a write operation (transaction), the memory controller writes a copy of the data to the primary and secondary side of the mirror. The process of making two or more copies of data for enhanced reliability is referred to as mirroring and sometimes Redundant Array of Independent Disks (RAID 1). It is not necessary that the primary and secondary side of the mirror are on different physical memory devices.

FIG. 1 is a prior art block diagram illustrating a prior art computer system with mirrored memory. Memory modules 100, 105, and 110 are the primary side of the memory in a computer system and memory modules 120, 125, and 130 are the secondary side of the memory. Other systems have a different number of memory modules. CPU 115 includes cores and cache memory 175 (as well as other components), a primary memory controller 135 coupled to the primary memory through interface 160, and a secondary memory controller 140 coupled to the secondary memory through interface 165. Different systems have different types and numbers of interfaces. Further, the primary and secondary memory controllers 135 and 140 could be two different memory controllers or two features of a single memory controller.

In mirroring, primary memory controller 135 and secondary memory controller 140 transfer the same data to the primary and secondary side of the memory so that the data is maintained in two copies in independent memory modules after each memory write operation. During a memory read operation 145, data is transferred from a memory module 100, 105, or 110 to primary memory controller 135. In the event the data is determined to be correct, no further actions are necessary to complete the read operation. In the event the data is determined to be corrupted, a read 170 may be performed by the secondary memory controller 140 from a memory module 120, 125, or 130 on the secondary side of the memory which contains a copy of the data stored on the primary side of the memory. This leads to higher reliability because even if data in on the primary side of memory is corrupted, a copy may be read from the secondary side that is probably not corrupted.

Checkpointing transfers and/or compares changed data between the first and the second computer systems. High reliability computers using checkpointing transfer data between the first computer system and the second computer system. An interface such as InfiniBand, PCI-Express (PCIe), or a proprietary interface between the computer systems is used to transfer the CPU state and the system memory content during the checkpointing process. The first computer system's CPU or Direct Memory Access (DMA) controller is usually used to transfer the contents of memory to the second computer system. Various methods are used to save time transferring the content of memory from the first computer system to the second computer system. For example, a memory paging mechanism may set a “Dirty Bit” to indicate that a page of memory has been modified. During checkpointing, only the pages of memory with the Dirty Bit set will be transferred. A page could be 4 Kilobytes, 2 Megabytes, 1 Gigabyte or some other size. The DMA device or processor copies the entire region of memory that has been identified by a Dirty Bit regardless of whether the entire page has been changed or only a few bytes of data in the page have changed.

Checkpointing reduces a computer system's performance. While the computer system is performing the checkpointing task, the computer system generally is not doing useful work for the user, so the user experiences reduced performance. There is always a tradeoff between frequency of checkpointing intervals, complexity of the method to efficiently transfer checkpoint data, and latency delays that the user experiences. Minimum latency can be realized by only transferring the data that has been changed in the computer memory.

Checkpointing may be used when both a first computer system and a second computer system are executing the same instructions. When both computer systems are executing the same code at the same time, they may be periodically stopped and the contents of the CPU registers and memory contents compared with each other. If the computer systems have identical CPU register values and memory contents, they are allowed to continue processing. When both computer systems are comparing memory and register values, a low latency comparison exists when only the data that has been changed is compared between the two systems. Various methods have been used in the prior art to reduce the amount of time necessary to copy the contents of external memory to the second computer system.

### BRIEF DESCRIPTION OF THE DRAWINGS

FIG. 1 is a block diagram representation of a prior art high reliability computer using memory mirroring.

FIG. 2 is a block diagram representation of a high reliability dual computer system according to some embodiments of the invention.

FIG. 3 is a block diagram representation of a high reliability dual computer system according to some embodiments of the invention.

FIG. 4 is a block diagram representation of further details of FIG. 3 according to some embodiments of the invention.

FIG. 5 is a block diagram representation of a high reliability dual computer system according to some embodiments of the invention.

FIG. 6 is a block diagram representation of a high reliability dual computer system according to some embodiments of the invention.

FIG. 7 is a block diagram representation of a high reliability dual computer system according to some embodiments of the invention.

FIG. 8 is a block diagram representation of further details of FIG. 2 according to some embodiments of the invention.

FIG. 9 is a block diagram representation of further details of FIG. 2 according to some embodiments of the invention.

FIG. 10 is a block diagram representation of a first computer system according to an embodiment of the invention.

FIG. 11 is a block diagram representation of a first computer system according to another embodiment of the invention.

FIG. 12 is a block diagram representation of a first computer system and a second computer system according to an embodiment of the invention.

FIG. 13 is a block diagram representation of a first computer system and a second computer system according to another embodiment of the invention.

FIG. 14 is a flow diagram of processing by a first computer system and a second computer system according to an embodiment of the invention.

### DETAILED DESCRIPTION

This disclosure relates to high reliability computer architectures. Specifically, this disclosure describes a low latency method of checkpointing to keep two computers in lockstep. In some embodiments (online, offline mode), the checkpointing operation can be performed faster because data is transferred during normal operation and does not need to be transferred during the checkpoint operation. In other embodiments (software lockstep mode), data does not need to be compared during the checkpoint operation because the data is compared during normal operation.

Memory controllers typically write only changed or new data to main memory (external memory modules), and when the computer system is using mirrored memory, the memory controller writes a duplicate copy of the new or changed data to both the primary and the secondary side of the mirror. By modifying the memory controller or the memory device to transfer data to a second computer system while writing the data to memory, checkpointing overhead is reduced or eliminated for the memory copy portion of checkpointing.

In some embodiments, a form of checkpointing (offline checkpointing) is used in which a first computer system (e.g., an online system) runs a user's application and periodically stops to copy internal and external data and the CPU state to a second computer (e.g., an offline system). The need to transfer memory contents during the checkpoint operation is reduced or eliminated by transferring data from the online system to the offline system during each memory write operation (transaction) while the first computer system is running the user's application.

In other embodiments, another form of checkpointing is used in which both a first and a second computer system are running a user's application concurrently (software lockstep mode). Periodically, both computer systems are stopped at the same time and point in an application. One system may be slightly ahead or behind the other system, so the system that is behind is allowed to run additional instructions until the two systems are stopped on the same instruction. Then the internal and external memory and CPU state are compared. Some embodiments reduce the need to compare external memory contents during the checkpoint operation by performing the external memory compare every time data is written to memory. Some embodiments only support software lockstep mode and other embodiments only support online, offline mode. Still other embodiments support both software lockstep mode and online, offline mode.

FIG. 2 is a block diagram illustrating some embodiments of a low overhead checkpointing system. FIG. 2 may be used to implement either form of checkpointing (software lockstep or online, offline modes) and variations of them described below.

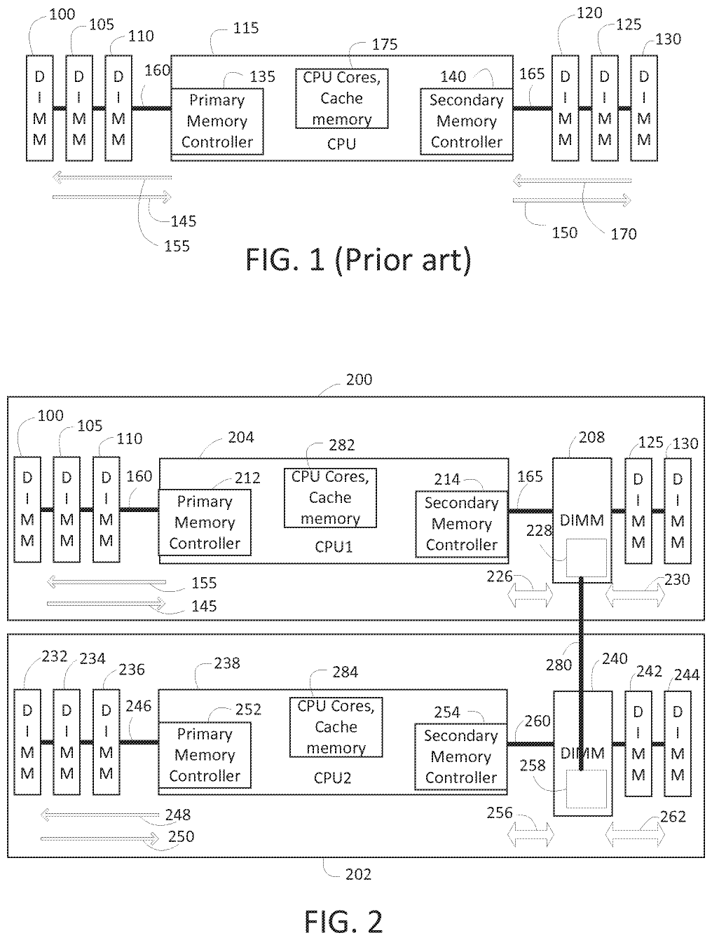

In FIG. 2, primary system 200 includes CPU1 204, memory modules 100, 105, and 110 on the primary memory side, and memory modules 208, 125, and 130 on the secondary memory side. CPU1 includes cores and cache memory 282 (which may be the same as or different than cores and cache memory 175), primary memory controller 212 and secondary memory controller 214, as well as various other components. Primary and secondary memory controllers 212 and 214 may be on the same die as CPU cores and cache memories 282 or on a different die. Primary and secondary memory controllers 212 and 214 may be separate memory controllers or two features of the same memory controller. CPU1 204, primary and secondary memory controllers 212 and 214 may be the same as or different than CPU 115, primary and secondary memory controllers 135 and 140 in FIG. 1.

Secondary system 202 includes CPU2 238, memory modules 232, 234, and 236 on the primary memory side, and memory modules 240, 242, and 244 on the secondary memory side. CPU2 includes CPU cores and cache memories 284 (which may be the same as or different than cores and cache 282), primary memory controller 252 and secondary memory controller 254 and other components. Memory module 208 includes memory devices and inter-memory transfer interface 228, and memory module 240 includes memory devices and inter-memory transfer interface 258.

In some embodiments, primary memory controller 212 and secondary memory controller 214 transfer the same data to the primary and secondary side of the memory so that the data is maintained in two copies in independent memory modules during each memory write operation.

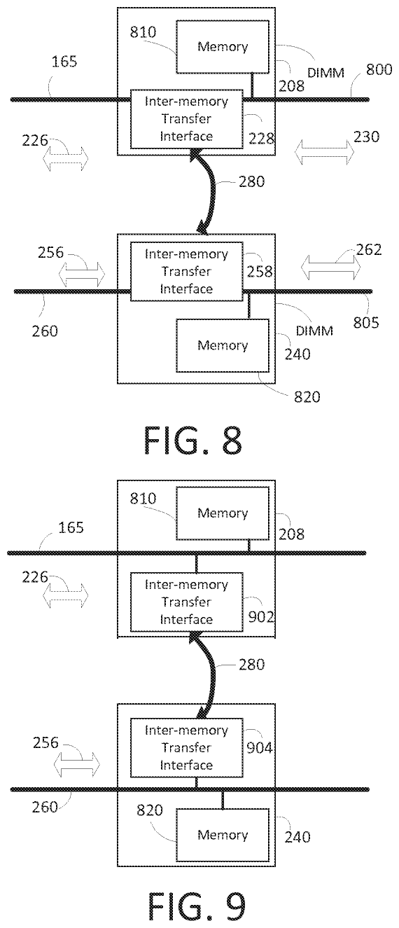

There are different ways in which memory write operations may be performed in different embodiments. FIGS. 8 and 9 illustrate some of these. Referring to FIGS. 2 and 8, during a memory write operation, CPU1 204 transfers data by writing 155 to a memory module 100, 105, or 110 on the primary side of the memory using memory interconnect 160. Concurrently with the write 155 to the primary side of the memory, CPU1 204 transfers data by writing 226 to inter-memory transfer interface 228 in memory module 208 on the secondary side using memory interconnect 165. Data is transferred 230 to memory in memory module 208, 125, or 130. During the write 226 process, inter-memory transfer interface 228 on memory module 208 signals secondary system 202 with information about the write using private interface 280 (which is an example of an interconnect). Secondary system inter-memory transfer interface 258 receives the information about the write over private interface 280. The inter-memory transfer interface 258 on secondary system secondary side memory module 240 performs a write 262 to memory in secondary side memory modules 240, 242, or 244. Note that memory controller 254 may be the same as or different than memory controller 214. Likewise, memory controllers 212 and 214 may be the same as each other or different and memory controllers 252 and 254 may be the same as or different (and may be separate memory controllers or two features of the same memory controller). The inter-memory transfer interfaces may be, for example, Application Specific Integrated Circuits (ASICs), Field Programmable Gate Arrays (FPGAs), or integrated into Dynamic Random-Access Memory (DRAM) devices.

In some embodiments for online, offline mode, secondary memory controller 254 in system 202 receives information 256 from inter-memory transfer interface 258 and causes CPU2 238 to write the same data to the primary side memory modules 232, 234, or 236 using primary memory controller 252. Upon completion of the writes 155, 226, 230, 262, and 248, the memory contents of the secondary system will be the same as the memory contents of the primary system. During the next offline checkpointing event, in some embodiments, there will be no need to transfer memory content or compare memory content because every write operation on the primary system has been repeated on the secondary system.

In some embodiments for online, offline mode, the secondary system inter-memory transfer interface 258 does not cause the data to be written to the primary side of the mirror so that the primary side contains the memory image of the last checkpoint operation. Write information provided over interface 280 is written to memory modules 240, 242, or 244 but is not transferred by CPU2 238 to the secondary system, primary memory. As the primary system runs, there is a possibility that there will be incorrect data written to the memory. If incorrect data is written to both sides of the mirrored memory on the primary system 200, and a copy of the bad data is written to the secondary system 202, there is a correct copy of data on the primary side of the mirror on the secondary system 202. To recover data or the operation during a checkpoint operation, the data from the previous checkpoint operation may be read from the secondary system 202 primary memory controller 252. In some embodiments, when data is only written to the secondary memory, during checkpointing the changed data on the secondary side of the mirror can be transferred to the primary side, thus preserving the previous checkpointed data on the primary side until it is safe to update with the changed data on the other side.

In some embodiments using the software lockstep mode, primary computer system 200 and secondary computer system 202 execute the same user program and run in software lockstep. Each computer system executes the same instructions at almost the exact same time. When the primary computer system 200 and the secondary computer system 202 write data to the primary system, secondary memory (in module 208, 125 or 130) and the secondary system, secondary memory (in module 240, 242, or 244), inter-memory transfer interface 228 and the inter-memory transfer interface 258 may compare the write information from transactions 226 and 256 when the write operations occur. During the next software lockstep checkpoint operation, memory contents do not need to be compared because every write occurring in the first system is compared to every write occurring in the second system concurrently with the writes by the inter-memory transfer interfaces 228 or 258 or both 228 and 258. The comparison of information related to write operations may be of the entire provided write information or merely a portion of it. Accordingly, at least some of the information is compared.

Referring again to FIGS. 2 and 8, in FIG. 8, writes pass through inter-memory transfer interfaces 228 and 258 before passing to memory 810 and 820 or other memory in modules 125, 130, 242, or 244 on interfaces 800 or 805. When information is received over private interface 280, a write to memory 230 or 262 can occur without using connection 165 or 260. Likewise, read data from modules 125, 130, 242, or 244 passes through interfaces 228 or 258 before being passed on interface 165 or 260. By contrast, in FIG. 9, data can be written to or read from memory 810, 904, or memory in modules 125, 130, 242, or 244 without passing through inter-memory transfer interfaces 902 or 904. Note that interfaces 902 and 904 may be the same as or different than interfaces 228 and 258.

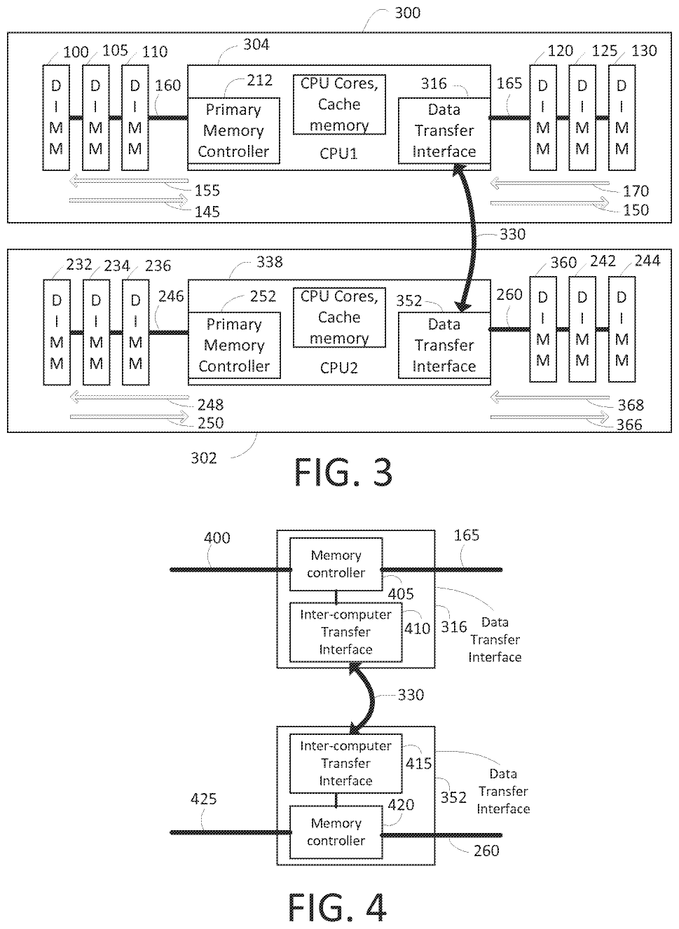

FIG. 3 illustrates some alternative embodiments. Referring to FIG. 3, primary system 300 and secondary system 302 are like systems 200 and 202 of FIG. 2 except that inter-memory interfaces 228 and 258 are not included in FIG. 8, and memory controllers 214 and 254 or FIG. 2 are replaced with data transfer interfaces 316 and 352 in FIG. 3. Further, private interface 280 is replaced with private interface 330 (which is an example of an interconnect) in the system of FIG. 3. Also, in FIG. 8, module 120 and 230 replace modules 208 and 240 of FIG. 2. (Note that although the modules are labeled Dual Inline Memory Modules (DIMM)s, they do not have to be DIMMs.)

In online, offline mode, during a memory write operation, CPU 304 transfers data by writing 155 to a memory module 100, 105, or 110 on the primary side of the memory using memory interconnect 160. Concurrently with the write 155 to the primary side of the memory, data transfer interface 316 transfers data by writing 150 to a memory module 120, 125, or 130 on the secondary side of the memory using memory interconnect 165. During the write 150 process, data transfer interface 316 signals secondary system 302 with information about the write using private interface 330. Secondary system data transfer interface 352 receives the information about the write from private interface 330. The data transfer interface 352 on secondary system CPU2 338 performs a write 366 to secondary side memory device 360, 242, or 244 and in some embodiments causes primary memory controller 252 to write (248) the same information to the primary memory in module 232, 234, or 236.

In some embodiments of online, offline mode, secondary system data transfer interface 352 transfers the information about the write from private interface 330 to the primary memory in module 232, 234, or 236 and secondary memory in module 360, 242, or 244 so that the data is maintained in two copies in independent memory modules during each memory write operation.

In some embodiments of online, offline mode, secondary system data transfer interface 352 transfers the signaled data from private interface 330 data to only the secondary 360, 242, and 244 side of the memory, preserving the contents of the primary side of the memory until the checkpointing process allows the changed data to be written to the primary side of the memory.

In some embodiments of the software lockstep mode, primary system 300 and secondary system 302 are running the same user application concurrently in software lockstep. When the two systems perform write operations (155, 150, 248, and 366) to primary and secondary memory, the primary system data transfer interface 316 and/or secondary system data transfer interface 352 compare information about write operations using information provided over private interface 330. During a software lockstep checkpoint operation, the contents of memory may not need to be compared because during each write operation while the primary and secondary systems are running, the write data is compared.

FIG. 4 provides additional detail of some embodiments of FIG. 3. Data transfer interface 316 includes a memory controller 405 and an inter-computer transfer interface 410. Data transfer interface 352 includes a second inter-computer transfer interface 415 and a memory controller 420. First inter-computer transfer interface 410 detects when a write occurs from CPU 304 over interface 400 to memory controller 405. Information about the write, such as the data being written, the address in memory it is being written to, and, optionally, the time that the data write occurred is transferred to the second inter-computer transfer interface 415 using a private interface 330.

In some embodiments in on-line offline mode, when interface 415 receives from interface 410 information about a data write, that interface 415 causes the second memory controller 420 to write a copy of the data from interface 410 to the second system memory attached to memory interface 260.

In some embodiments when systems 300 and 302 are operating in software lockstep, interface 410 detects when CPU 304 writes to memory controller 405. Information about the write, such as the data being written, the address in memory it is being written to, and, optionally, the time that the data write occurred is transferred by interface 410 to interface 415 using private interface 330. Interface 415 detects when CPU 338 writes over interface 425 to memory controller 420. Information about the write, such as the data being written, the address in memory it is being written to, and, optionally, the time that the data write occurred is compared to the information signaled from interface 410. If the data is the same, the memory does not need to be compared during the next software lockstep checkpoint because all of the changed values were compared when written to memory, thus reducing the time needed to perform software lockstep checkpointing. The comparison can be performed in interface 410 or in 415 or in both 410 and 415. In alternative embodiments, the comparison could be performed in other circuitry of the system outside the interfaces. For example, the comparison could be performed in the cores, the memory controller, or other circuitry of the CPUs.

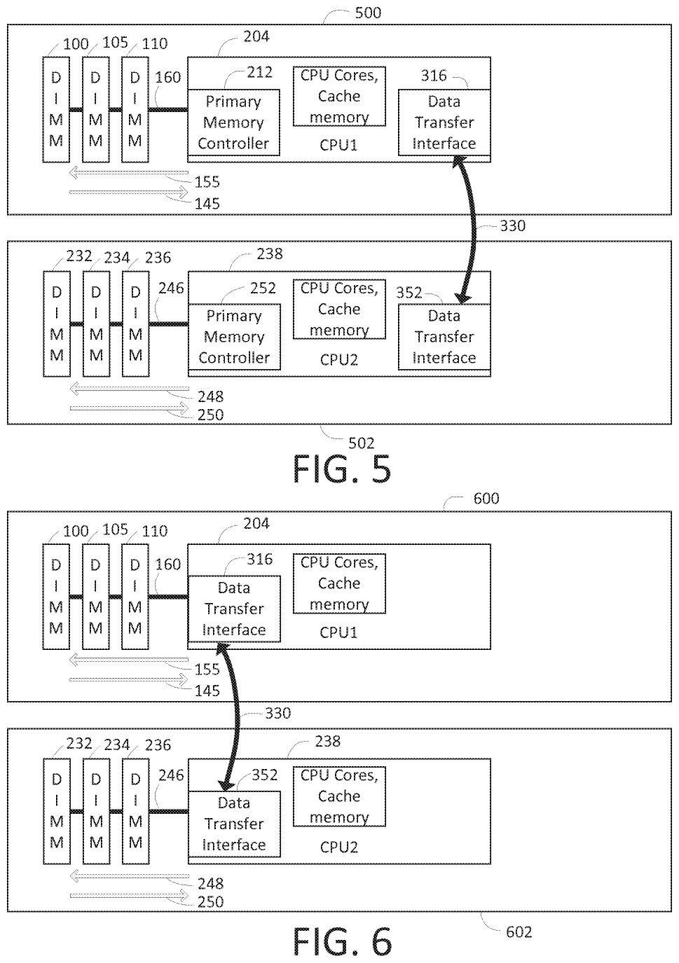

FIG. 5 illustrates other embodiments. FIG. 5 is similar to FIG. 3 except that systems 500 and 502 do not include memory modules connected to the data transfer interfaces 316 and 352. Accordingly, there will be writes to the primary side of the second system 502 in on-line, offline mode.

FIG. 6 illustrates other embodiments. FIG. 6 is similar to FIG. 5 except that in systems 600 and 602, the data transfer interface 316 and 352 replace memory controllers 212 and 252. In still other embodiments, systems like those in FIG. 3 could have data transfer interfaces 316 and 352 on the primary side and memory controllers 212 and 252 on the secondary side.

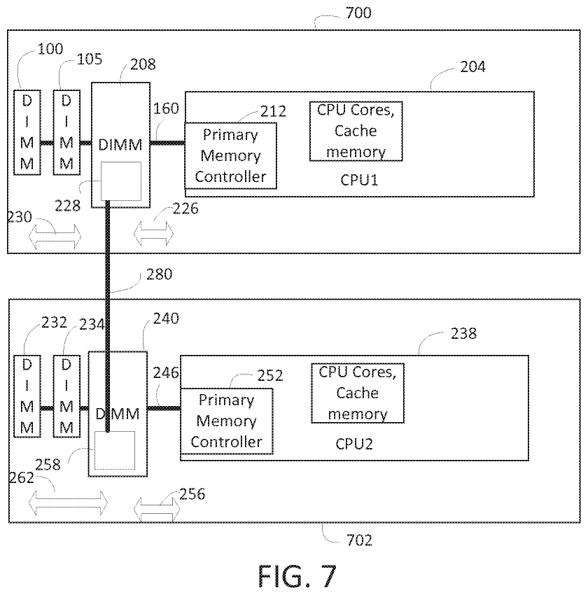

FIG. 7 illustrates other embodiments. FIG. 7 is similar to FIG. 2, except that modules 208 and 240 are on the primary side and there is no secondary side. In some embodiments, there could also be a secondary side. In other words, in FIG. 2, modules 208 and 240 could be swapped with modules 110 and 236 with private interface 280 being moved as well.

Some embodiments of the present invention comprise an unobtrusive sideband check on memory writes for lockstep systems (as described above) that provide an earlier indication that a CPU is no longer in lockstep with another CPU than by means of stopping and comparing the state of both CPUs. When using these embodiments, the user may have more confidence in the stability of the lockstep systems and use that additional confidence to relax the frequency of checkpoint activity thereby, increasing perceived performance of the lockstep systems. These embodiments provide advantages over the embodiments described above, because those embodiments for hardware and software lockstep solutions required saving the CPU context and comparing memory locations as well as CPU registers individually, which slows down the checkpointing step. Also, until a checkpoint occurs, the user is not aware if a CPU has broken out of lockstep.

In response, in embodiments described below a signature generator is provided that creates a unique digital signature for address and data information being written to main memory from a CPU 204, 238. This information is generated on both systems 200, 202 in a high reliability server running in lockstep. The signatures are compared in real-time to ensure that memory writes on both systems contain the same information and are sent to the same address at nearly the same time. This provides an advantage that CPUs falling out of lockstep are detected sooner than in other methods. Thus, checkpoint operations may be scheduled with longer delays between them since this embodiment provides earlier detection of issues.

In one embodiment, the digital signature generated by the signature generator is a hash of at least the address and data. In another embodiment, the digital signature generated by the signature generator is a cyclic redundancy check (CRC) value computed over at least the address and the data. In another embodiment, other information, such as a time stamp, counter value or nonce, for example, may also be included in the digital signature. In other embodiments, other digital signatures may be used depending on implementation choices. Any suitable hash or CRC computation known in the art may be used for digital signature generation.

As described above, hardware lockstep uses two identical computer systems running in clock by clock “lockstep” so that each computer system is executing the same instruction at approximately the same time, and both systems should have identical content in their memories. The two computer systems appear to be a single system to the user. Software lockstep also uses two systems, one running as the primary and the other running as the secondary. The secondary system monitors the primary system to ensure that it continues to operate. Both systems contain the same memory image which allows either one to continue to operate if one system fails. However in order to stay in lockstep, the primary and secondary system periodically halt; one system will execute enough additional instructions to “catch up” to the other, then they compare internal states and memory contents (changes to memory since the last comparison) in order to verify that both systems are operating correctly.

Having a redundant set of computer systems provides a mechanism for maintaining highly reliable operations. If one system has a failure, the other system continues to run the user's software (providing the high reliability) and allows the failing computer/component to be reset or replaced while still running the user's software. Once ready to continue operation, the system is brought back into lockstep (hardware or software) and high reliable operation can continue. While only one computer system is in operation the system is subject to a second failure and is not in a highly reliable condition.

To recover from a failure, a system management interrupt (SMI) is generated on the running system, and during the interrupt routine, the running system copies the current state of the operating processor and the entire memory contents of the operating processor to the recovering or second system. After copying the contents, including on-CPU cache and CPU registers, both systems will contain identical data. Once both CPUs and memory contents match, a resume from SMI can be executed simultaneously causing the two systems to run in a high reliability state.

A feature of a hardware lockstep system is the detection of when the two computer systems fall out of lock (lockstep error). A feature of a software lockstep system is ensuring an exact copy of memory exists (in some scenarios, a software lockstep system detects a failure by a simple “are you there” exchange.)

Some embodiments provide a memory write access digital signature mechanism for computer systems running in a high reliability mode 1) to detect a hardware out of lock condition (e.g., a lockstep error), 2) to minimize the amount of memory that needs to be copied to get back into lockstep (to minimize the amount of time the system is not running in lockstep), 3) by comparing the digital signatures, two systems can quickly determine if the memory contents are the same, and 4) by comparing the difference in time for when the digital signatures are created, the amount of slip between two systems can be measured without having to stop them and compare program counters.

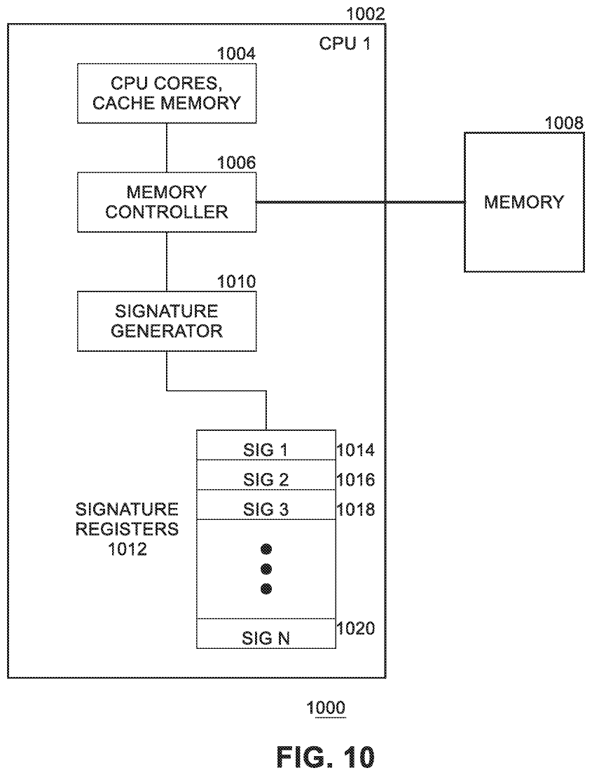

FIG. 10 is a block diagram representation of a first computer system 1000 according to an embodiment of the invention. First computer system 1000 includes CPU 1 1002 having CPU cores and cache memory 1004 and memory controller 1006. Memory controller 1006 is coupled to memory 1008. Embodiments of the present invention require a memory space, denoted herein as one or more signature registers 1012, to store one or more digital signatures, each digital signature representing performance of a write operation of the address and data being written out of CPU 1 1002 by memory controller 1006 into memory 1008. In an embodiment, there are one or more signature registers 1012, such as sig 1 1014, sig 2 106, sig 3 108, . . . sig N 1020, where N is a natural number. In an embodiment, signature registers may be used as a first-in, first-out (FIFO) queue (e.g., the oldest signatures in the signature registers are replaced with newer signatures). In an embodiment, CPU 1 1002 includes signature generator 1010 to generate a hash value or CRC based at least in part on the address and data (and optionally the time that the write occurred) for a write operation. In an embodiment, separate sets of signature registers 1012 may be associated with each memory controller, if the CPU include multiple memory controllers. A hash or CRC can be used with high confidence to detect differences in memory content because the hash or CRC has the characteristic that if a single bit is different between two sets of (address and) memory contents, the hash or CRC will be different. It is unlikely that a multiple bit error in the data and address would be created such that the hash or CRC codes would match. As used herein, “hash” or “CRC” may be used alone or in combination without limitation, and they may be substituted for each other.

In an embodiment, signature registers 1012 are cleared by a power on reset or by a model specific register (MSR) write to the signature registers. In various embodiments, signature registers may be global for an entire system, pertain to a single CPU (such as CPU 1 1002), single memory controller 1006, single or multiple memory channels, multiple CPUs, or multiple memory controllers.

During operation, writes from CPU cores 1004 to internal memory are captured in the CPU's cache. When more writes occur than the cache can hold, an external memory write may be used to take the least frequently used cache entry and write the contents to memory 1008. During this write to memory 1008, signature generator 1010 creates a hash or CRC value for at least the address and content of the memory being written thereby creating a unique digital signature for that combination of address and data. A second computer system running in lockstep will be executing the same instructions at the same time and will therefore generate the same hash or CRC value simultaneously during the write to memory. In this scenario, immediate detection of a second computer system falling out of lockstep with a first computer system is provided.

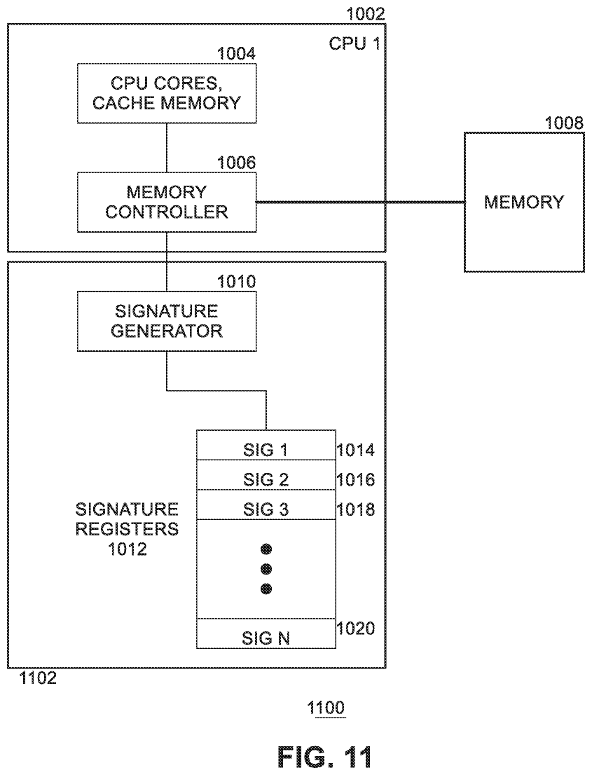

FIG. 11 is a block diagram representation of a first computer system 1100 according to another embodiment of the invention. First computer system 1100 is similar to first computer system 1000 of FIG. 10, but in this embodiment signature generator 1010 and signature registers 1012 are not located on CPU 1 1002 (e.g., not on the processor die). In this embodiment signature generator 1010 and signature registers 1012 are located on another component 1102 of first computer system 1100 accessible by CPU 1 1002.

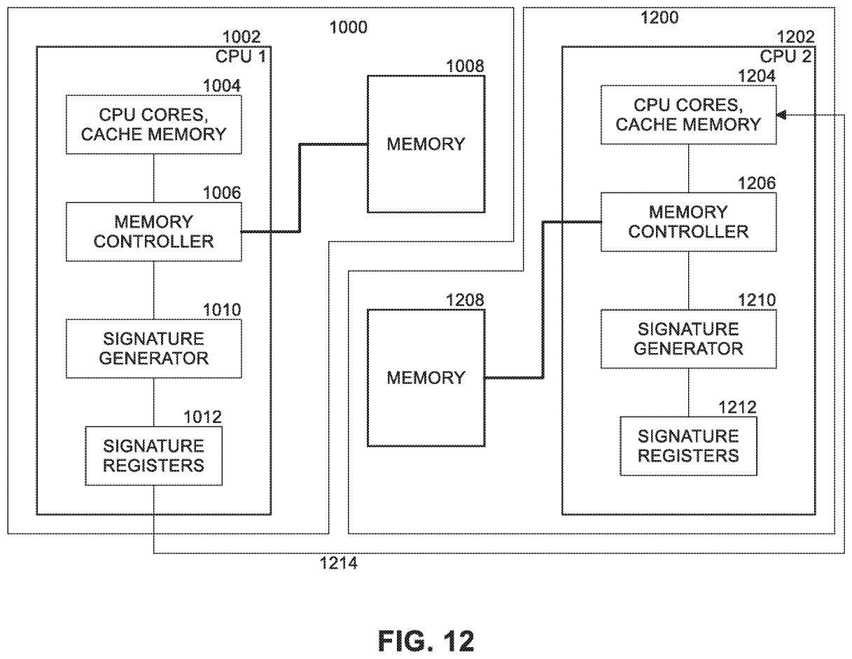

FIG. 12 is a block diagram representation of a first computer system 1000 and a second computer system 1200 according to an embodiment of the invention. In this embodiment, first computer system 1000 and second computer system 1200 are operating in lockstep. First computer system 1000 includes CPU 1 1002 having CPU cores and cache memory 1004, memory controller 1006, signature generator 1010, signature registers 1012, and memory 1008 as shown in FIG. 10. Similarly, second computer system 1200 includes CPU 2 1202 having CPU cores and cache memory 1204, memory controller 1206, signature generator 1210, signature registers 1212, and memory 1208. In this embodiment, when a digital signature is generated by signature generator 1010 (as a result of performance of write operation to memory 1008) and stored in signature registers 1012 on CPU 1 1002, the digital signature is also sent (represented by line 1214) to CPU 2 1202 (e.g., to CPU cores 1204). CPU 2 1202, operating in lockstep, generates a digital signature for the matching write operation to memory 1208. CPU 2 1202 then compares the digital signature received from CPU 1 1002 with the digital signature generated by CPU 2 1202 and detects if a lockstep error has occurred. In an embodiment, optionally the time that the digital signatures were generated is also compared to determine if a lockstep error has occurred. In this embodiment, the comparison is performed by hardware in CPU 2 1202 or by software instructions being executed by CPU 2 1202.

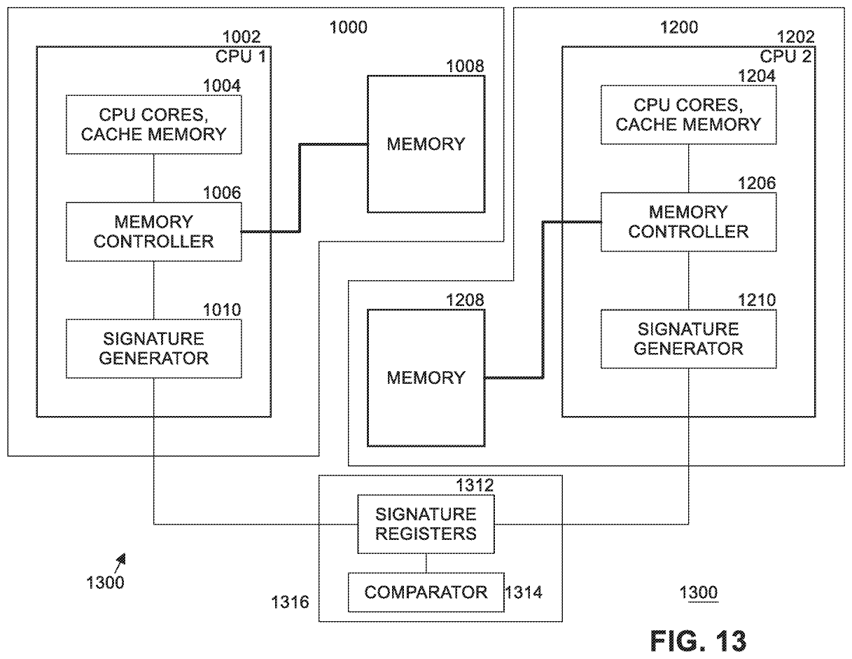

FIG. 13 is a block diagram representation of a first computer system 1000 and a second computer system 1200 according to another embodiment of the invention. In this embodiment, signature registers 1312 are commonly used by first computer system 1000 and second computer system 1200 and are not integral with CPU 1 1002 or CPU 2 1202 (e.g., not on CPU 1's die or CPU 2's die). Signature registers 1314 and comparator circuitry 1314 are instead in a separate component 1316 of overall computing system 1300. Each of CPU 1 1002 and CPU 2 1202 store digital signatures in commonly used signature registers 1312 in component 1316. Comparator circuitry 1314 in component 1316 compares a digital signature written by CPU 1 1002 to an associated (e.g., by lockstep) digital signature written by CPU 2 1202 and indicates a lockstep error if the digital signatures do not match.

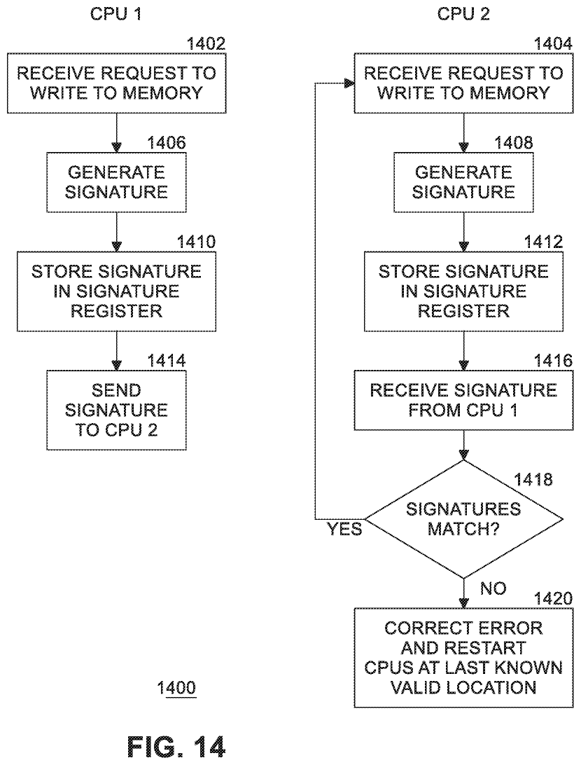

FIG. 14 is a flow diagram 1400 of processing by a first computer system 1000 and a second computer system 1200 according to an embodiment of the invention. The actions of FIG. 14 may be performed by the embodiment shown in FIG. 12. On CPU 1 1002, at block 1402 memory controller 1006 receives a request to write to memory 1008. At block 1406, signature generator 1010 generates a digital signature representing the write operation. Signature generator 1010 stores the signature in one of the signature registers 1012 at block 1410. Substantially in parallel, on CPU 2 1202 at block 1404 memory controller 1206 receives a request to write to memory 1208. At block 1408, signature generator 1210 generates a digital signature representing the write operation. Signature generator 1210 stores the signature in one of the signature registers 1212 at block 1412. At block 1414, CPU 1 1002 sends the signature stored in signature register 1012 to CPU 2 1202. At block 1416, CPU 2 1202 receives the signature from CPU 1. At block 1418, CPU 2 1202 compares the signature received from CPU 1 to the signature generated by signature generator 1210 on CPU 2 1202. If the signatures match (and optionally the time when the signatures were generated match), the first and second computer systems are in lockstep operation and processing continues with blocks 1402 and 1404, by CPU 1 and CPU 2, respectively. If the signatures do not match, at block 1420, CPU 2 1202 initiates actions to correct the error. In an embodiment these actions include restarting the CPUs at the last known valid location (e.g., where the CPUs were known to be in lockstep) in the program being executed by the CPUs.

In another embodiment, the digital signatures saved in signature registers 1012 are not compared immediately (e.g., in real-time) but on a periodic basis. In an embodiment, the digital signatures are compared when a checkpoint operation is performed. In either of these embodiments, the digital signature mechanism described above is used to create a set of DIMM CRC registers (called memory block signature registers herein) that are placed in the memory controller's write buffers for each DIMM (including both address and data). The memory block signature registers can be read via an MSR read operation. The memory block signature registers are cleared on a power on reset or by an MSR write to a memory block signature register.

After a software lockstep checkpoint operation completes (e.g., the primary computer system has copied all the memory content writes to the secondary computer system) the memory block signature registers can be compared to ensure the contents of the memories are identical. Not all of memories will be identical since the two systems are running different software, but the section of memory containing the backup memory image will be identical and have identical signatures.

For a system using a hardware mechanism as described above to copy the memory contents, the same mechanism is used to verify the contents are indeed still identical.

For a system not using a hardware mechanism as described above, the signature generator feature can be used to determine when a memory block need to be copied during a checkpoint operation (to copy any changed memory from the primary computer system to the secondary computer system); the signature registers could be compared between the two systems to indicate which sections of memory have changed and need to be copied.

When a hardware lockstep miss-compare occurs the memory block signature registers can be interrogated and compared between the two computer systems that had been running in lockstep. If the memory block signature registers are the same, the memory contents are identical and no copy is required. If any registers are different this indicates that there is a memory difference on the corresponding memory and that memory must be copied from the “good” memory contents to the “bad” memory contents to make the memory contents of the two computer systems identical. Once all the necessary copies are complete the two computer's memory systems are again identical; the computer systems can then be taken back into hardware lockstep by a reset and resume from SMI.

An optimum number of memory block signature registers can be determined by how long it will take to perform the memory copy. Additional registers can be added to limit the amount of memory (partial DIMM) that needs to be copied, reducing the time the system is out of lock.

A system running in hardware lockstep could have a “slip” in the execution, for example, one system may have a stall for a correctable error correcting code (ECC) error while the other system would not need the correction. Both systems will be using identical data (since the error was corrected), but one system will have slipped its execution by one or more clocks since the data was delivered to the processor at a later time. Subsequent writes to the write buffer will have identical addresses and data but will be output at different times. This could (depending on the implementation) generate an out of lock indication, however all memory block signature registers will have the same values (one write will be delayed but will occur) so no memory copy is needed and letting one CPU execute a few more instructions to catch up to the other CPU will quickly put the system back into lockstep. Likewise, even if the systems are slightly out of lockstep, there can be a timing threshold where operations may continue for a brief time until the slower system makes a memory write. If the length of time is greater than a predetermined threshold, the systems may need to be stopped and re-aligned.

One or more aspects of at least one example may be implemented by representative instructions stored on at least one tangible, non-transitory machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGAs, AI cores, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing detailed description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the detailed description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
a first computer system operating in lockstep with a second computer system;
the first computer system including a first memory and a first central processing unit (CPU), a first memory controller, a first signature generator to generate a first digital signature representing a first write operation by the first memory controller to the first memory, the first write operation to store data at an address in the first memory, and a first signature register to store the first digital signature; and
the second computer system including a second memory and a second CPU, a second memory controller, a second signature generator to generate a second digital signature representing a second write operation by the second memory controller to the second memory, the second write operation to store the data at the address in the second memory, and a second signature register to store the second digital signature;
wherein the second CPU to compare the first digital signature to the second digital signature and to detect a lockstep error when the first digital signature does not match the second digital signature.

2. The system of claim 1, wherein the first signature generator to generate a first hash value of at least the data and the address as the first digital signature and the second signature generator to generate a second hash value of at least the data and the address as the second digital signature.

3. The system of claim 1, wherein the first signature generator to generate a first hash value of at least the data, the address, and a first time stamp as the first digital signature, and the second signature generator to generate a second hash value of at least the data, the address, and a second time stamp as the second digital signature.

4. The system of claim 1, wherein the first signature generator to generate a first cyclic redundancy check (CRC) value of at least the data and the address as the first digital signature, and the second signature generator to generate a second CRC value of at least the data and the address as the second digital signature.

5. The system of claim 1, wherein
the first computer system includes the first memory and the first CPU and the first memory controller, and a first component including the first signature generator and the first signature register; and
the second computer system includes the second memory and the second CPU and the second memory controller, and a second component including the second signature generator and the second signature register.

6. The system of claim 1, comprising:
a third component including one or more signature registers and a comparator, the comparator to compare at least two digital signatures of the one or more signature registers to detect the lockstep error when the at least two digital signatures do not match;
wherein the first computer system includes the first memory and the first CPU, the first memory controller, and the first signature generator; and
wherein the second computer system includes the second memory and the second CPU, the second memory controller, and the second signature generator.

7. A method comprising:
receiving, at a first memory controller of a first computer system including a first memory and a first central processing unit (CPU) and the first memory controller, a request to perform a first write operation by the first memory controller to the first memory, the first write operation to store data at an address in the first memory;
generating, by a first signature generator of the first computer system, a first digital signature representing the first write operation;
storing, by the first signature generator, the first digital signature in a first signature register of the first CPU;
receiving, at a second memory controller of a second computer system including a second memory and a second CPU and the second memory controller, a request to perform a second write operation by the second memory controller to the second memory, the second write operation to store the data at the address in the second memory, the second computer system operating in lockstep with the first computer system;
generating, by a second signature generator of the second computer system, a second digital signature representing the second write operation;
storing, by the second signature generator, the second digital signature in a second signature register of the second CPU; and
comparing the first digital signature to the second digital signature and detecting a lockstep error when the first digital signature does not match the second digital signature.

8. The method of claim 7, wherein the first signature generator generates the first hash value of at least the data and the address as the first digital signature and the second signature generator generates the second hash value of at least the data and the address as the second digital signature.

9. The method of claim 7, wherein the first signature generator generates the first hash value of at least the data, the address, and a first time stamp as the first digital signature, and the second signature generator generates the second hash value of at least the data, the address, and a second time stamp as the second digital signature.

10. The method of claim 7, wherein the first signature generator generates a first cyclic redundancy check (CRC) value of at least the data and the address as the first digital signature, and the second signature generator generates a second CRC value of at least the data and the address as the second digital signature.

11. The method of claim 7, wherein the first computing system performs the receiving, generating, and storing steps substantially in parallel with the second computing system performing the receiving, generating, and storing.

12. The method of claim 11, comprising sending the first digital signature to the second CPU before comparing the first digital signature to the second digital signature.

13. The method of claim 7, comprising restarting the first CPU and the second CPU at a last known valid location when the lockstep error is detected.

14. At least one non-transitory machine-readable medium comprising a plurality of instructions that in response to being executed by a processor in a computer system cause the computer system to:
receive, at a memory controller of the computer system including a memory and a CPU and the memory controller, a request to perform a write operation by the memory controller to the memory, the write operation to store the data at an address in the memory, the computer system operating in lockstep with a second computer system;
generate, by a signature generator of the computer system, a digital signature representing the write operation;
store, by the signature generator, the digital signature in a signature register of the CPU;
receive a second digital signature representing a second write operation by a second memory controller to a second memory in the second computer system; and
compare the digital signature to the second digital signature and detect a lockstep error when the digital signature does not match the second digital signature.

15. The at least one non-transitory machine-readable medium of claim 14, comprising instructions, that when executed, generate a hash value of at least the data and the address as the digital signature.

16. The at least one non-transitory machine-readable medium of claim 14, comprising instructions, that when executed, generate a hash value of at least the data, the address, and a time stamp as the digital signature.

17. The at least one non-transitory machine-readable medium of claim 14, comprising instructions, that when executed, generate a cyclic redundancy check (CRC) value of at least the data and the address as the digital signature.

18. The at least one non-transitory machine-readable medium of claim 14, comprising instructions, that when executed, restart the CPU at a last known valid location when the lockstep error is detected.
